(19) United States
(12) Patent Application Publication
(10) Pub. No.: US 2018/0061396 A1
(43) Pub. Date: Mar. 1, 2018

(54) METHODS AND SYSTEMS FOR KEYWORD DETECTION USING KEYWORD REPETITIONS

(71) Applicant: Knowles Electronics, LLC, Itasca, IL (US)

(72) Inventors: Sundararajan SRINIVASAN, Sunnyvale, CA (US); Sridhar Krishna NEMALA, Mountain View, CA (US); Jean LAROCHE, Santa Cruz, CA (US)

(73) Assignee: Knowles Electronics, LLC, Itasca, IL (US)

(21) Appl. No.: 15/679,689

(22) Filed: Aug. 17, 2017

Related U.S. Application Data
(60) Provisional application No. 62/379,173, filed on Aug. 24, 2016.

(51) Int. Cl. G10L 15/07; G10L 15/00; G06F 17/30

(52) U.S. Cl. CPC G10L 15/07; G10L 2015/088; G06F 17/3074; G10L 15/005

(57) ABSTRACT

Systems and methods for keyword detection using keyword repetitions are provided. An example method includes receiving an acoustic signal representing at least one captured sound. Using a keyword model, a first confidence score for the first acoustic signal may be acquired. The method also includes determining the first confidence score is less than a detection threshold within a first value. In response, lowering the threshold by a second value for a pre-determined time interval. The method also includes receiving a second acoustic signal captured during the pre-determined time interval and acquiring a second confidence score for the second acoustic signal. The method also includes determining the second confidence score equals or exceeds the lowered threshold, and then confirming keyword detection. The threshold may be restored after the pre-determined time interval. The keyword model may be temporarily replaced by a tuned keyword model to facilitate keyword detection in low SNR conditions.

### CROSS-REFERENCE TO RELATED APPLICATIONS

The present application claims priority to U.S. Provisional Patent Application No. 62/379,173 filed Aug. 24, 2016, the contents of which are incorporated herein by reference in their entirety.

### TECHNICAL FIELD

The present embodiments relate generally to audio or acoustic signal processing and more particularly to systems and methods for keyword detection in acoustic signals.

### BACKGROUND

Voice keyword wakeup systems may monitor an incoming acoustic signal to detect keywords used to trigger wakeup of a device. Typical keyword detection methods include determining a score for matching the acoustic signal to a pre-determined keyword. If the score exceeds a pre-defined detection threshold, the keyword is considered to be detected. The pre-defined detection threshold is typically chosen to balance between having correct detections (e.g., detections when the keyword is actually uttered) and having false detections (e.g., detections when the keyword is not actually uttered). However, wakeup systems can miss detecting keyword utterances. This is especially true in difficult environments, for example, those having highly noisy, mismatched reverberant conditions, or high level of echo for barge-in (interruptions by other speakers, music). It can also be especially challenging to reduce false alarms (e.g., detections made that are actually incorrect) without increasing the false reject rate (e.g., the rate of failing to detect valid keyword utterances.

### SUMMARY

According to certain general aspects, the present technology relates to systems and methods for keyword detection in acoustic signals. Various embodiments provide methods and systems for facilitating more accurate and reliable keyword recognition when a user attempts to wake up a device or system, to launch an application on the device, and so on. For improving accuracy and reliability, various embodiments recognize that, when a keyword utterance is not recognized, users tend to repeat the keyword within a short time. Thus, within a short interval, there may be two pieces of the acoustic signal for which a confidence score may come close to the detection threshold, even if the confidence score does not exceed the detection threshold to trigger confirmation of keyword detection. In such situations, to facilitate detection of the keyword, it can be very valuable to loosen a criterion for keyword detection within the short interval, and/or to tune the keyword model used, according to various embodiments described herein.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIG. 1 is a block diagram illustrating a smart microphone environment in which the method for keyword detection using keyword repetitions can be practiced, according to various example embodiments.

FIG. 2 is a block diagram illustrating a smart microphone package, in which the method for keyword detection using keyword repetitions can be practiced, according to various example embodiments.

FIG. 3 is a block diagram illustrating another smart microphone environment, in which the method for keyword detection using keyword repetitions can be practiced, according to various example embodiments.

FIG. 4 is a plot of a confidence score for detection of a keyword in a captured acoustic signal, according to an example embodiment.

FIG. 5 is a flow chart illustrating a method for keyword detection using keyword repetitions, according to an example embodiment.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

Various embodiments of the present technology can be practiced with any electronic device operable to capture and process acoustic signals. In various embodiments, the electronic device can include smart microphones. The smart microphones may combine into a single device an acoustic sensor (e.g., a micro electro mechanical system (MEMS device)), along with a low power application specific integrated circuit (ASIC) and a low power processor used in conjunction with the acoustic sensor. Various embodiments can be practiced in smart microphones that include voice activity detection and keyword detection for providing a wakeup feature in a more power efficient manner.

In some embodiments, the electronic device can include hand-held devices, such as wired and/or wireless remote controls, notebook computers, tablet computers, phablets, smart phones, smart watches, personal digital assistants, media players, mobile telephones, and the like. In certain embodiments, the audio devices can include a personal desktop computer, television sets, car control and audio systems, smart thermostats, and so on.

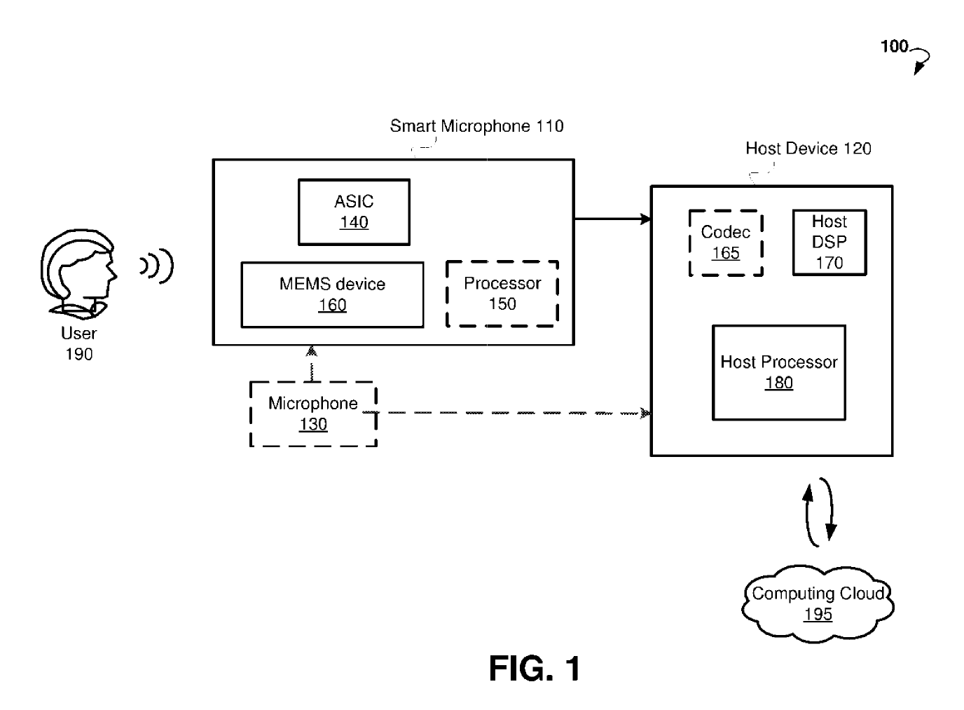

Referring now to FIG. 1, an environment 100 is shown in which the present technology can be practiced. The example environment 100 can include a smart microphone 110 which may be communicatively coupled to a host device 120. The smart microphone 110 can be operable to capture an acoustic signal, process the acoustic signal, and send the processed acoustic signal to the host device 120.

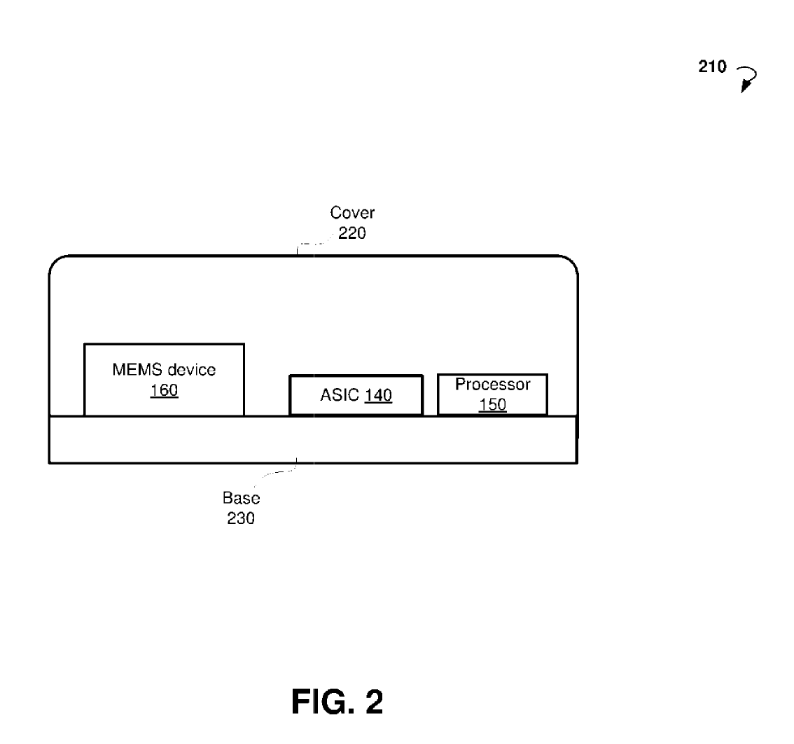

In various embodiments, the smart microphone 110 includes at least an acoustic sensor, for example, a MEMS device 160. In various embodiments, the MEMS device 160 is used to detect acoustic signals, such as, for example, verbal communications from a user 190. The verbal communications can include keywords, key phrases, conversation, and the like. In various embodiments, the MEMS device may be used in conjunction with elements disposed on an application-specific integrated circuit (ASIC) 140. ASIC 140 is described further in regards to examples in FIGS. 2-4.

In some embodiments, the smart microphone 110 may also include a processor 150 to provide further processing capability. The processor 150 is implemented with circuitry. The processor 150 may be operable to perform certain processing, with regard to the acoustic signal captured by the MEMS device 160, at lower power than such processing can otherwise be performed in the host device 120. For example, the ASIC 140 may be operable to detect voice signals in the acoustic signal captured by MEMS device 160 and generate a voice activity detection signal based on the detection. In response to the voice detection signal, the processor 150 may be operable to wake up and then proceed to detect one or more pre-determined keywords or key phrases in the acoustic signals. In some embodiments, this detection functionality of processor 150 may be integrated into the ASIC 140, eliminating the need for a separate processor 150. For the detection functionality, a pre-stored list of keyword or key phrases may be compared word or phrases in the acoustic signal.

Upon detection of the one or more keywords or key phrases, the smart microphone 110 may initiate wakeup of the host device 120 and start sending captured acoustic signals to the host device 120. If no keyword or key phrase is detected, then wakeup of the host device 120 is not initiated. Until being woken up, the processor 150 and host device 120 may operate in a sleep mode (consuming no power or very small amounts of power). Further details of environment 100 and the smart microphone 110 and host device 120 in this regard are described below and with respect to examples in FIGS. 2-5.

Referring to FIG. 1, in some embodiments, the host device 120 includes a host DSP 170, a (main) host processor 180, and an optional codec 165. The host DSP 170 can operate at lower power than host processor 180. The host DSP 170 is implemented with circuitry and may have additional functionality and processing power, requiring more operational power and physical space, compared to processor 150. In response to wake up being initiated by the smart microphone 110, the host device 120 may wake up and turn on functionality to receive and process further acoustic signals captured by the smart microphone 110.

In some embodiments, the environment 100 may also have a regular (e.g., non-smart) microphone 130. The microphone 130 may be operable to capture the acoustic signal and provide the acoustic signal to the smart microphone 110 and/or to the host device 120 for further processing. In some embodiments, the processor 150 of the smart microphone 110 may be operable to perform low power processing of the acoustic signal captured by the microphone 130 while the host device 120 is kept in a lower power sleep mode. In certain embodiments, the processor 150 may continuously perform keyword detection in the obtained acoustic signal. In response to detection of a keyword, the processor 150 may send a signal to the host device 120 to initiate wake up of the host device to start full operations.

In some embodiments, the host DSP 170 of the host device 120 may be operable to perform low power processing of the acoustic signal captured by the microphone 130 while the main host processor 180 is kept in a lower power sleep mode. In certain embodiments, the host DSP 170 may continuously perform the keyword detection in the obtained acoustic signal. In response to detection of a keyword, the host DSP 170 may send a signal to the host processor 180 to wake up to start full operations of the host device 120.

The acoustic signal (in a form of electric signals) captured by the microphone 130 may be converted by codec 165 to digital signals. In some embodiments, codec 165 includes an analog-to-digital converter. The digital signals can be coded by codec 165 according to one or more audio formats. In some embodiments, the smart microphone 110 provides the coded digital signal directly to the host processor 180 of the host device 120, such that the host device 120 does not need to include the codec 165.

The host processor 180, which can be an application processor (AP) in some embodiments, may include a system on chip (SoC) configured to run an operating system and various applications of host device 120. In some embodiments, the host device 120 is configured as an SoC that comprises the host processor 180 and host DSP 170. The host processor 180 may be operable to support memory management, graphics processing, and multimedia decoding. The host processor 180 may be operable to execute instructions stored in a memory storage (not shown) of the host device 120. In some embodiments, the host processor 180 is operable to recognize natural language commands received from user 190 using automatic speech recognition (ASR) and perform one or more operations in response to the recognition.

In other embodiments, the host device 120 includes additional or other components used for operations of the host device 120. For example, the host device 120 may include a transceiver to communicate with other devices, such as a smartphone, a tablet computer, and/or a cloud-based computing resource (computing cloud) 195. The transceiver can be configured to communicate with a network such as the Internet, a Wide Area Network (WAN), a Local Area Network (LAN), a cellular network, and so forth, to send and receive data. In some embodiments, the host device 120 may send the acoustic signals to computing cloud 195, request that ASR be performed on the acoustic signal, and receive back the recognized speech.

FIG. 2 is a block diagram showing an example smart microphone package 210 that packages the smart microphone 110. The smart microphone package 120 may include a MEMS device 160, an ASIC 140 and a processor 150, all disposed on a substrate or base 230 and enclosed by a housing (e.g., cover 220). The cover 220 may extend at least partially over and be coupled to the base 230 such that the cover 220 and the base 230 form a cavity. A port (not shown in the example in FIG. 2), may extend through the substrate or base 230 (for a bottom port device) or through the cover 220 of the housing (for a top port device).

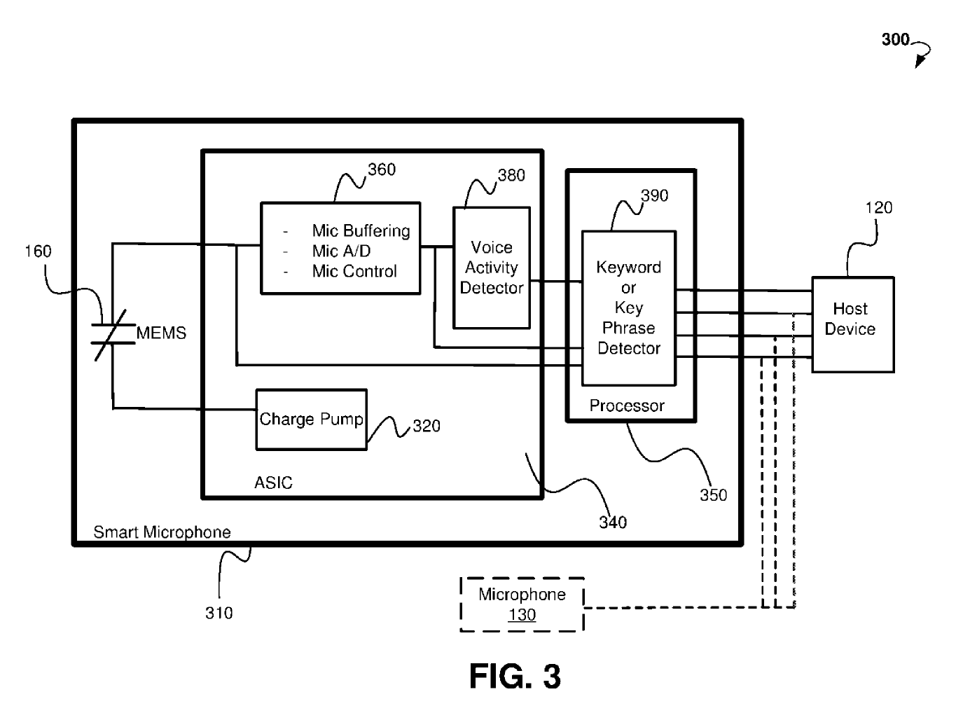

FIG. 3 illustrates another example smart microphone environment 300 in which a method according to some example embodiments of the present technology can be practiced. The example smart microphone environment 300 includes a smart microphone 310 which is an example embodiment of smart microphone 110 in FIG. 1. The smart microphone 310 is configured to communicate with a host device 120. In some embodiments, the host device 120 may be integrated with the smart microphone 310 into a single device. In certain embodiments, the smart microphone environment 300 includes an additional regular (non-smart) microphone 130 coupled to the host device 120.

The smart microphone 310 in the example in FIG. 3 includes an acoustic sensor in the form of MEMS device 160, along with an ASIC 340, and a processor 350. In various embodiments, the elements of the smart microphone 310 are implemented as combinations of hardware and programmed software. The MEMS device 160 may be coupled to the ASIC 340 on which at least some of the elements of the smart microphone 310 may be disposed, as described further herein.

The ASIC 340 is an example embodiment of the ASIC 140 in FIGS. 1-2. The ASIC 340 may include a charge pump 320, a buffering and control element 360, and a voice activity detector 380. Element 360 is referred to as the buffering and control element, for simplicity, even though it may have various other elements such as A/D converters. Example descriptions including further details regarding a smart microphone that includes a MEMS device, an ASIC having a charge pump, buffering and control element and voice activity detector may be found in U.S. Pat. No. 9,113,263, entitled “VAD Detection Microphone and Method of Operating the Same,” and U.S. Patent Application Publication No. 2016/0098921, entitled “Low Power Acoustic Apparatus and Method of Operation,” both of which are incorporated by reference in their entirety herein.

Referring again to FIG. 3, the charge pump 320 can provide current, voltage and power to the MEMS device 160. The charge pump 320 charges up a diaphragm of the MEMS device 160. An acoustic signal including voice may move the diaphragm, thereby causing the capacitance of the MEMS device 160 to change creating a voltage to generate an analog electrical signal. It will be appreciated that if a piezoelectric sensor is used, the charge pump 320 is not needed.

The buffering and control element 360 may provide various buffering, analog to digital (A/D) conversion and various gain control, buffer control, clock, and amplifier elements for processing acoustic signals captured by the MEMS device, configured for use variously by the voice activity detector 380, the processor 350 and ultimately to the host device 120. An example describing further details regarding elements of an example ASIC of a smart microphone may be found in U.S. Pat. No. 9,113,263, entitled “VAD Detection Microphone and Method of Operating the Same,” which is incorporated by reference in its entirety herein.

In various embodiments, the smart microphone 310 may operate in multiple operational modes. The modes can include a voice activity detection (VAD) mode, a signal transmit mode, and a keyword or key phrase detection mode.

While operating in VAD mode, the smart microphone 310 may consume less power than in the other modes. While in VAD mode, the smart microphone 310 may operate for detection of voice activity using voice activity detector 380. In some embodiments, upon detection of voice activity, a signal may be sent to wake up processor 350.

In certain embodiments, the smart microphone 310 detects whether there is voice activity in the received acoustic signal, and in response to the detection, also detects whether the keyword or key phrase is present in the received acoustic signal. The smart microphone 310 can operate in these certain embodiments, to send a wakeup signal sent to the host device 120 in response to detecting both the presence of the voice activity and the presence of the key word or key phrase. For example, the ASIC 340 may detect voice signals in the acoustic signal captured by MEMS device 160, and generate a voice activity detection signal. In response to the voice detection signal, the keyword or key phrase detector 390 in processor 350 may be operable to wake up and then proceed to detect whether one or more pre-determined keywords or key phrases are present in the acoustic signals.

The processor 350 is an embodiment of the processor 150 in FIGS. 1-2. The processor 350 may store a list of keyword or key phrases that it compares against word or phrases in the acoustic signal. Upon detection of the one or more keywords, the smart microphone 310 may initiate wakeup of the host device 120 and start sending captured acoustic signals to the host device 120. However, if no keyword or key phrase is detected in various embodiments, then no wakeup signal is sent to wakeup the host device 120. Until receiving the wakeup signal, the processor 150 and host device 120 may operate in a sleep mode (consuming no power or very small amounts of power). Another example of use of a processor for keyword or key phrase detection in a smart microphone may be found in U.S. Patent Application Publication No. 2016/0098921, entitled “Low Power Acoustic Apparatus and Method of Operation,” which is incorporated by reference in its entirety herein.

In some embodiments, the functionality of the keyword or key phrase detector 390 may be integrated into the ASIC 340 which may eliminate the need to have a separate processor 350.

In other embodiments, the wakeup signal and acoustic signal may be sent to the host device 120 from the smart microphone 310 just in response to the presence of the voice activity detected by the smart microphone 310. The host device 120 may then operate to detect the presence of the key word or key phrase in the acoustic signal. Host DSP 170 shown in the example in FIG. 1 may be utilized for the detection. An example describing further details regarding keyword detection in a host DSP may be found in U.S. Pat. No. 9,113,263, entitled “VAD Detection Microphone and Method of Operating the Same,” which is incorporated by reference in its entirety herein.

The host device 120 in FIG. 3 is described above with respect to the example in FIG. 1. The host device 120 may be part of a device, such as, but not limited to, a cellular phone, a smart phone, a personal computer, a tablet, and so forth. In some embodiments, the host device is communicatively connected to a cloud-based computational resource (also referred as a computing cloud).

In response to receiving the wakeup signal, the host device 120 may start a wakeup process. After the wakeup latency, the host device 120 may provide the smart microphone 310 with a clock signal (for example, 768 kHz). In response to receiving the external clock signal, the smart microphone 310 may enter a signal transmit mode. In signal transmit mode, the smart microphone 310 may provide buffered audio data to the host device 120. In some embodiments, the buffered audio data may continue to be provided to the host device 120 as long as the host device 120 provides the external clock signal to the smart microphone 110.

The host device 120 and/or the computing cloud 195 may provide additional processing including noise suppression and/or noise reduction and ASR processing on the acoustic data received from the smart microphone 110.

In various embodiments, keyword or key phrase detection may be performed based on a keyword model. The keyword model can be a machine learning model operable to analyze a piece of the acoustic signal and output a score (also referred as a confidence score or a keyword confidence score). The confidence score may represent probability that the piece of the acoustic signal matches a pre-determined keyword. In various embodiments, the keyword model may include one or more of a Gaussian mixture model (GMM), a phoneme hidden Markov model (HMM), a deep neural network (DNN), a recurrent neural network, a convolutional neural network, and a support vector machine. In various embodiments, the keyword model may be user-independent or user-dependent. In some embodiments, the keyword model may be pre-trained to run in two and more modes. For example, the keyword model may run in a regular mode in high signal-to-noise (SNR) ratio environment and a low SNR mode for noisy environments.

It should be appreciated that, although the term keyword is used herein in certain examples, for simplicity, without also referring explicitly to key phrases, the use may be repeating a key phrase in practicing various embodiments.

As a user 190 speaks a keyword or a key phrase, the confidence score may keep increasing. In some embodiments, the keyword is considered to be present in the piece of the acoustic signal if the confidence score equals or exceeds a pre-determined (keyword) detection threshold. Experiments have shown that, in many cases in which the keyword is not detected even though the user spoke it, the confidence value is close to (but below) the predetermined threshold. Similarly, usage tests show that users typically repeat the keyword when it is not recognized the first time. These observations indicate that within a short interval, there may be two pieces of the acoustic signal for which a confidence score comes close to the detection threshold, even if the confidence score does not exceed the detection threshold to trigger confirmation of keyword detection. In such situations, it is advantageous to loosen a criterion for keyword detection within the short interval.

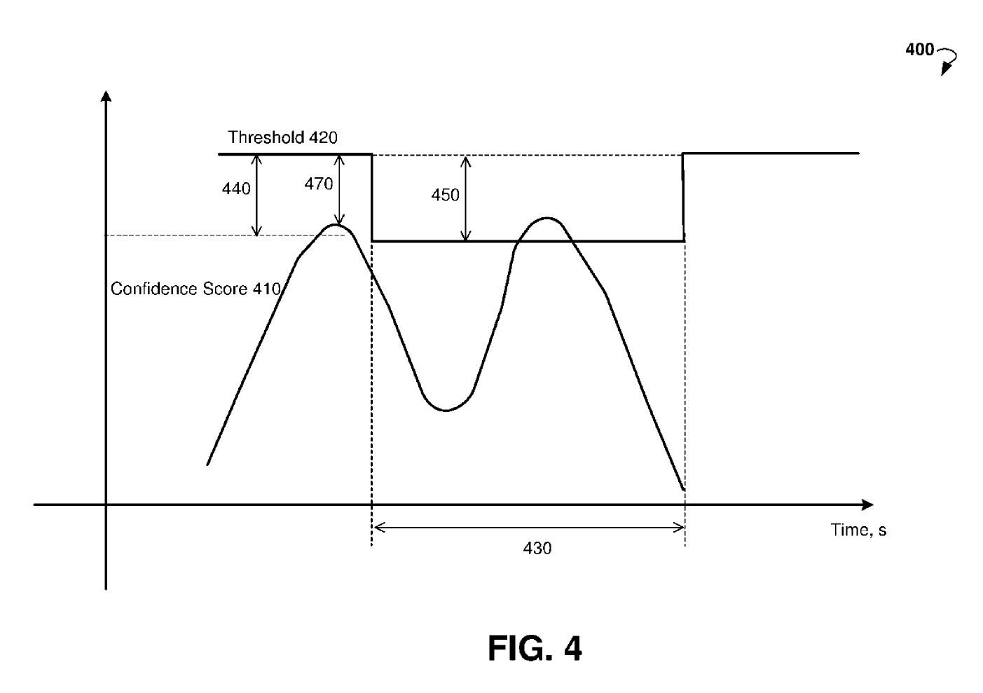

FIG. 4 shows an example plot 400 of an example confidence score 410. The example confidence score 410 is determined for an acoustic signal captured when user 190 utters a keyword (for example, to wake up a device) and then repeats the keyword one more time. During the first utterance of the keyword, the confidence score 410 may be lower than the detection threshold 420 by a discrepancy 470.

In some embodiments, if the discrepancy 470 does not exceed a pre-determined first value 440, the threshold 420 may be lowered by a second value 450 for a short time interval 430. In various embodiments, the first value 440 may be set in a range of 10% to 25% of the threshold 420, which experiments have shown to be an acceptable value. In some embodiments, the first value 440 is set to 20% of the threshold 420. If the first value 440 is too low, false alarms are more likely to occur. If the first value 440 is set too high, the confidence score 410 may not exceed it during the first utterance, preventing the lowering of the threshold from occurring. The second value 450 may be set equal to or larger than the first value 440, so that when the user 190 utters the keyword again during the time interval 430, the confidence score 410 may reach the lowered threshold. Note that, if the threshold is lowered by too large a value, false alarms are more likely to occur each time a near detection occurs. If the threshold is lowered by too small a value, the second repetition of the keyword may still not be recognized. In some embodiments, the time interval 430 may be equal to 0.5-5 seconds as experiments have shown that users typically repeat the keyword within such a short period. Too long an interval may cause additional false alarms, while too short an interval may prevent a successful detection during the repetition of the keyword. The first value 440, the second value 450, and the time interval 430 can be configurable by the user 190 in some embodiments. In some other embodiments, the second value 450 may be a function on the actual value of the discrepancy 470. When the time interval 430 is complete, the detection threshold 420 may be set back to the original value.

It should be noted that, although FIG. 4 shows the second value 450 for lowering the threshold 420 as being constant over time interval 430, this is not necessary in all embodiments. In some embodiments, the second value 450 can be non-constant over time interval 430, such as being initially the same as first value 440 and then gradually decreasing to zero over time interval 430, for example in a linear fashion. Many variations are possible. Moreover, in some embodiments, the duration of time interval 430 can itself be non-constant and can vary at different times or under different circumstances. For example, the duration of time interval 430 can be adjusted adaptively over time based on keyword detection confidence patterns.

In other embodiments, after the near detection, the original keyword model can be temporarily replaced, for the time interval 430, by a model tuned to facilitate detection of the keyword. For example, the replacement keyword model can be trained using noisy training data that contain higher levels of noise (e.g., a low SNR environment), or in the case of GMMs, the model could include more mixtures than the original model, or include artificially broadened Gaussian variances. Experiments have shown that such tuning of the replacement keyword model may increase the value for the confidence score 410 when the same utterance of a keyword is repeated. The replacement keyword model can be used instead of, or in addition to, using the lowering of the detection threshold 420 for the time interval 430. In various embodiments, after a pre-determined time interval is passed, the original keyword model is restored, e.g., by detuning the tuned keyword model or otherwise replacing the tuned keyword model with the original keyword model.

According to various embodiments, if the confidence score 410 equals or exceeds the original threshold 420 during a second utterance of keyword, then the keyword is considered to be detected.

Both the lowering of the detection threshold and the tuning of the keyword model might otherwise increase chances for false keyword detection, however that is compensated by relying on the uncorrelated nature of false detection within the short window of time in which the keyword is repeated. This uncorrelated nature reduces the likelihood of having false keyword detection associated with the repetition of a keyword.

In yet other embodiments, the repeating of a keyword may be a requirement for the keyword detection. One reason for requiring the repeating is that it may be useful in certain circumstances (for example, when a user accidently uses a key phrase in conversation) to avoid unwanted detection and actions triggered therefrom. For example, a user may use the keyword “find my phone” to trigger the phone to make a sound, play a song, and so forth. Some embodiments may require the user to repeat “find my phone” twice in order to trigger the phone to perform the operation to avoid making the sound or playing the song if the phrase “find my phone” happened to be used in conversation, due to the nature of this key phrase.

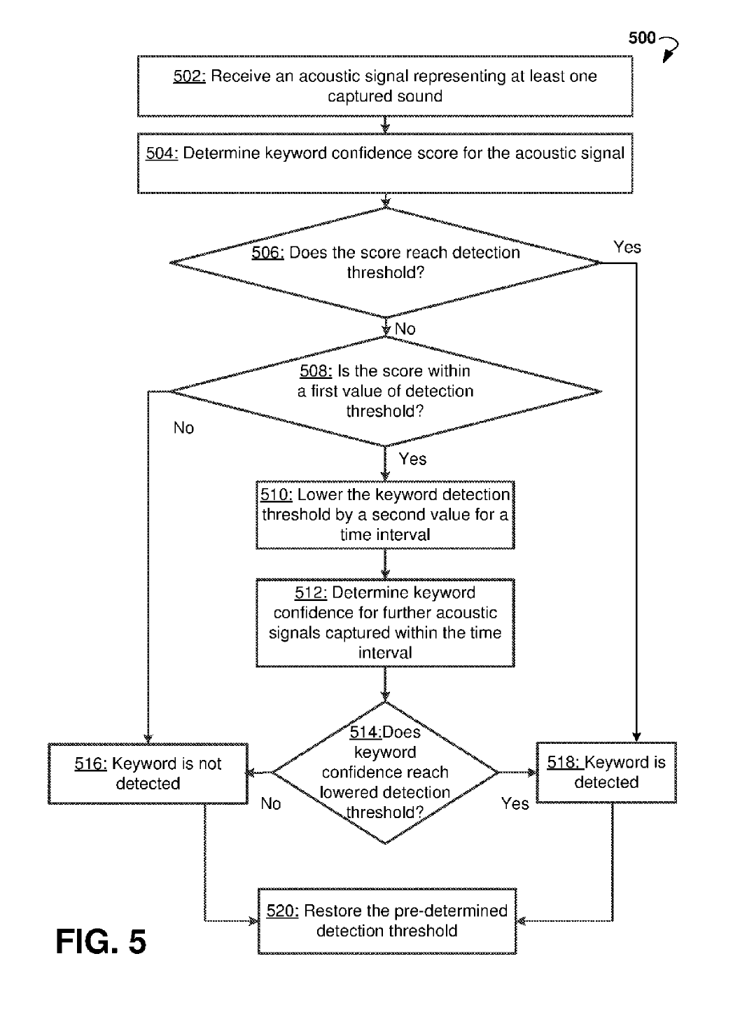

FIG. 5 is a flow chart showing steps of a method 500 for keyword detection, according to an example embodiment. For example, the method 500 can be implemented in environment 100 using the example smart microphone 110 in FIG. 1. In other embodiments, the method 500 is implemented using both the smart microphone 110 and the host device 120. For example, the smart microphone 110 may be used for capturing an acoustic signal and detecting voice activity, while using the host device 120 (for example, the host DSP 170) may be used for processing of the captured acoustic signal to detect a keyword. In yet other embodiments, the method 500 also uses the regular microphone 130 for capturing the acoustic sound.

In some embodiments, the method 500 commences in block 502 with receiving an acoustic signal. The acoustic signal represents at least one captured sound. In block 504, the method 500 includes determining a keyword confidence score for the acoustic signal. In some embodiments, the confidence score can be acquired/obtained using a keyword model operable to analyze the acoustic signal and determine the confidence score.

In block 506, the method 500 includes comparing the keyword confidence score to a pre-determined detection threshold. If the confidence score reaches or is above the detection threshold, the method 500 proceeds with confirming that the keyword is detected in block 518. If the confidence score is lower than the detection threshold, then the method 500 includes, in block 508, determining whether the confidence score is within a first value of the detection threshold. In various embodiments, the first value may be set in a range of 10% to 25% of the detection threshold, which experiments have shown to be an acceptable value. In some embodiments, the first value is set to 20% of the detection threshold. If the confidence score is not within the first value of the detection threshold, then the method 500 proceeds with confirming that the keyword is not detected in block 516.

In block 510, if the confidence score is within the first value of the detection threshold, then the method 500 proceeds with lowering the detection threshold for a certain time interval (for example 0.5-5 sec). In block 512, the method 500 includes determining a further confidence score for further acoustic signals captured within the certain time interval. In block 514, the method 500 includes determining whether the further confidence score equals or exceeds the lowered detection threshold. If the further confidence score is less than the lowered detection threshold, then the method 500 proceeds with confirming that keyword is not detected in block 516. If the further confidence score is above or equal to the lowered detection threshold, the method 500 proceeds with confirming that keyword is detected in block 518.

In block 520, the method 500 in the example in FIG. 5 includes restoring the original value of the detection threshold after the certain time interval is passed.

Although the present embodiments have been particularly described with reference to preferred ones thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. A method for keyword detection, the method comprising:
receiving a first acoustic signal, the first acoustic signal representing at least one captured sound;
acquiring, using a keyword model, a first confidence score for the first acoustic signal;
determining that the first confidence score is less than a detection threshold within a first value;
lowering the detection threshold by a second value for a pre-determined time interval;
receiving a second acoustic signal, the second acoustic signal representing at least one sound captured during the pre-determined time interval;
acquiring, using the keyword model, a second confidence score for the second acoustic signal;
determining that the second confidence score equals or exceeds the lowered detection threshold; and
confirming keyword detection.

2. The method of claim 1, wherein the pre-determined interval is between 0.5 and 5 seconds.

3. The method of claim 1, wherein the first value is in a range of 10% to 25% of the detection threshold.

4. The method of claim 1, further comprising, after the pre-determined time interval is passed, raising the lowered detection threshold to restore the detection threshold.

5. The method of claim 1, wherein the second value is a function of the first value.

6. The method of claim 1, wherein the keyword model includes a machine learning model operable to analyze the first and second acoustic signals and determine the first and second confidence scores, each of the confidence scores being a measure of the respective acoustic sounds matching a pre-determined keyword.

7. The method of claim 6, wherein the machine learning model includes at least one of the following: a Gaussian mixture model, a phoneme hidden Markov model, a deep neural network, a recurrent neural network, a convolutional neural network, and a support vector machine.

8. The method of claim 1, further comprising:
wherein the keyword model is a first keyword model, and in response to the determining that the first confidence score is less than the detection threshold within the first value, replacing the first keyword model with a second, tuned keyword model for a pre-determined time interval, wherein the second confidence score is acquired using the second, tuned keyword model; and
after the pre-determined time interval is passed, restoring back the first keyword model.

9. The method of claim 8, wherein the second, tuned keyword model is trained for use in low signal-to-noise ratio (SNR) conditions.

10. The method of claim 9, wherein the configuring of the second, tuned keyword model includes pre-training the second, tuned keyword model using noisy data from a low SNR environment.

11. The method of claim 8, wherein the second, tuned keyword model is trained for use in high SNR conditions.

12. A system for keyword detection, the system comprising:
an acoustic sensor; and
a circuit, communicatively coupled to the acoustic sensor and configured to execute instructions to:
receive a first acoustic signal, the first acoustic signal representing at least one sound captured by the acoustic sensor;
acquire, using a keyword model, a first confidence score for the first acoustic signal;
determine that the first confidence score is less than a detection threshold within a first value;
lower the detection threshold by a second value for a pre-determined time interval;
receive a second acoustic signal, the second acoustic signal representing at least one sound captured by the acoustic sensor during the pre-determined time interval;
acquire, using the keyword model, a second confidence score for the second acoustic signal;
determine that the second confidence score equals or exceeds the lowered detection threshold; and
confirm keyword detection.

13. The system of claim 12, wherein the first value is in a range of 10% to 25% of the detection threshold.

14. The system of claim 12, wherein the circuit is further configured to execute instructions to, after the pre-determined time interval, raise the lowered detection threshold to restore the detection threshold

15. The system of claim 12, wherein the second value is a function of the first value.

16. The system of claim 12, wherein the pre-determined interval is between 0.5 and 5 seconds.

17. The system of claim 12, wherein the keyword model is a first keyword model, the system further comprising:
the circuit being further configured to execute instructions to:
in response to the determining, that the first confidence score is less than the detection threshold within the first value, replacing the first keyword model with a second, tuned keyword model for a pre-determined time interval, wherein the second confidence score is acquired using the second, tuned keyword model; and
after the pre-determined time interval is passed, restoring the first keyword model.

18. The system of claim 17, wherein the second, tuned keyword model is trained for use in low SNR conditions.

19. The system of claim 18, wherein the configuring of the second, tuned keyword model includes pre-training the second, tuned keyword model using noisy data from a low SNR environment.

20. A system for keyword detection, the system comprising:
means for receiving a first acoustic signal, the first acoustic signal representing at least one captured sound;
means for acquiring, using a keyword model, a first confidence score for the first acoustic signal;
means for determining that the first confidence score is less than a detection threshold within a first value;
means for lowering the detection threshold by a second value for a pre-determined time interval;
means for receiving a second acoustic signal, the second acoustic signal representing at least one sound captured during the pre-determined time interval;
means for acquiring, using the keyword model, a second confidence score for the second acoustic signal;
means for determining that the second confidence score equals or exceeds the lowered detection threshold;
means for confirming keyword detection; and
means for, after the pre-determined time interval is passed, raising the lowered detection threshold to restore the detection threshold.
